(19) United States
(12) Patent Application Publication
(10) Pub. No.: US 2008/0281042 A1
(43) Pub. Date: Nov. 13, 2008

(54) GREASE RESISTANT FORMULATIONS

(75) Inventors: David S. Soane, Chestnut Hill, MA (US); Michael C. Berg, Somerville, MA (US); Patrick Duggan Kincaid, Hanover, MA (US); William A. Mowers, Lynn, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: NanoPaper, LLC, Cambridge, MA (US)

(21) Appl. No.: 11/857,630

(22) Filed: Sep. 19, 2007

Related U.S. Application Data
(60) Provisional application No. 60/845,886, filed on Sep. 20, 2006.

(51) Int. Cl. C08B 3/00; B32B 23/06

(52) U.S. Cl. 525/54.21; 428/535; 428/522; 428/514; 428/479.6; 428/425.1; 428/413

(57) ABSTRACT

Disclosed herein are grease-resistant compositions that can include a cellulose-based polymer and a complementary material. Such compositions can be applied to substrates, such as paper-based materials, to impart enhanced grease/oil resistance. The complementary material can act to provide the composition with enhanced fatigue resistance relative to layers that solely utilize the cellulose-based polymer, and can preferably have limited leaching from the composition. Examples of complementary materials include polymers, such as poly(vinyl acetate) and poly(vinyl alcohol), plasticizers, and combinations of these materials. Such compositions can be prepared as a treatment formulation or coating material, which can be dissolved or suspended in a solvent. The compositions may also be melted and applied without a solvent. The formulations can be a water-based system, or an emulsion. The films may be applied to paper products as part of the papermaking process, or as post treatments on a coating machine.

### CROSS REFERENCE TO RELATED APPLICATIONS

The present application claims the benefit of a U.S. Provisional Application bearing Ser. No. 60/845,886, filed Sep. 20, 2006, entitled “Grease Resistant Films,” the entire contents of which is hereby incorporated by reference herein.

### FIELD OF THE APPLICATION

The present application relates to the fabrication and use of thin films, coatings, and other formulations using a cellulose-based material.

### BACKGROUND

Grease-resistant and/or oil-resistant coatings are used in a variety of applications including paper and board used in food packaging. Many of these treatments or coatings use fluorinated materials, and others use high amounts of polyolefins or other plastics. Concerns by consumers and regulatory agencies are driving the search for alternative coating materials. In addition to concerns regarding the safety of fluorinated materials, polyolefins or other plastics often make the paper non-recyclable, or too brittle to allow folding or creasing of the treated paper. Plastics can be modified with small molecule plasticizers, but these types of plasticizers are undesirable since they can be extracted into the oil or food. Also, many plasticized plastics have limited heat stability. For these reasons, an alternative coating material is needed that can withstand heat from cooking, be conformable to creasing or folding, and withstand the penetration of oil or grease. It is further desirable that this material be aqueous based for use in certain papermaking processes.

Attempts have been made in the past to construct such a paper sheet. For example, U.S. Pat. No. 2,976,205 describes the preparation of webs and sheets from cellulose esters. As another example, U.S. Pat. No. 3,103,462 discloses a method for improving the strength characteristics of paper by including a partially acetylated cellulose fiber. U.S. Pat. No. 3,261,899 discloses a process for making synthetic fiber paper comprising a cellulose acetate fiber. The methods disclosed above produce papers that have high levels of cellulose acetate, which raises the cost of these synthetic papers relative to more traditional paper products. In addition, the level of cellulose acetate in these products may give rise to properties that are not optimal for conventional paper applications.

Other technologies are known in the art for modifying fibrous products containing cellulosic fibers to improve the water-resistance and grease-resistance of such products without impairing their mechanical properties and without yielding any undesirable byproducts. As examples, see U.S. Pat. Nos. 4,116,625, 5,610,233, 6,645,584, 6,656,984, 6,780,903, and 7,052,540.

There remains a need in the art, however, for a coating or film that is applied to paper products to enhance their resistance to water and/or to grease while retaining their mechanical strength and their thermal stability. Desirably, such a film may be produced economically, and without invoking regulatory or environmental concerns.

### SUMMARY

Some embodiments are directed to methods of producing a grease-resistant substrate, such as a paper product. A surface of a paper product can be coated with a treatment composition. The coating can include treating the paper surface by solvent-casting, spraying, dip coating, or extrusion. Optionally, the step of coating can also include forming at least a portion of the paper product simultaneously using the treatment composition. The treatment composition can include a cellulose-based polymer and a complementary material. Examples include the cellulose-based polymer comprising any of a cellulose ester and a cellulose ether, and the complementary material comprising any of a polyvinyl acetate and a polyvinyl alcohol. Treatment compositions can also include any other types of cellulose-based polymers, complementary materials, and other components disclosed herein. Such a treatment composition can either include, or be substantially free, of a small molecule plasticizer. The treatment composition can be a water-based composition and/or can be an emulsion and/or can be a polymer melt. The treatment composition can also have grease-resistant properties such as being more grease-resistant than the paper product. As well, the treatment composition can form a layer that is less brittle than a layer of the cellulose-based polymer. Methods can optionally include forming a free-standing layer with the treatment composition. The free-standing layer can be applied (e.g., attached) to a surface of the substrate by appropriate techniques such as lamination.

Other embodiments are directed to a grease-resistant paper product. In general, grease-resistant paper products can be utilized for a number of applications such as food packaging materials. Such grease resistant paper products can include a treated surface of a paper-based material. The treated surface can include a layer of a treatment composition. The treatment composition can include a cellulose-based polymer and a complementary material, such as a complementary polymer. In some instances, the treatment composition layer can be less brittle than an equally thick layer of the cellulose-based polymer. The treated surface of the paper-based material can be more grease-resistant than an untreated surface of the paper-based material.

Some embodiments are directed to grease-resistant paper products that can include a treated surface of a paper-based material. The treated surface can include a layer of a treatment composition which includes a cellulose-based polymer and a complementary material. The complementary material can be incapable of substantial leaching out of the layer, such as some complementary polymer. The treatment composition layer can be less brittle than an equally thick layer of the cellulose-based polymer. The treated surface of the paper-based material can be more grease-resistant than an untreated surface of the paper-based material.

In some embodiments, a grease-resistant composition for laminating upon a substrate (e.g., paper-based materials) can include a free standing grease-resistant layer (e.g., a free standing layer capable of repelling a grease-based fluid). The layer can include a cellulose-based polymer and a complementary polymer. The layer can also be less brittle than an equally thick layer of the cellulose-based polymer, and can be adapted to be attached to the substrate. In other embodiments, a grease-resistant layer can include a layer of a treatment composition, which can comprise a cellulose-based polymer and a complementary polymer. The layer can be less brittle than an equally thick layer of the cellulose-based polymer.

With regard to the treatment compositions or layers in various embodiments, the composition/layer can be substantially free of cellulose fibers and/or small molecule plasticizers. The composition/layer can also exhibit limited phase-separation morphology, and can optionally maintain its grease-resistant properties at high temperatures (e.g., above 80° C., 90° C., or 100° C.). The composition/layer can also be crosslinked, for example by using a crosslinking agent. In various compositions/layers, the cellulose-based polymer can be a cellulose ether (which can optionally include crystalline domains) or a cellulose ester, and can have high hydroxyl content. Examples of cellulose esters include a cellulose acetate, a cellulose butyrate, a cellulose propionate, and a carboxymethyl cellulose. Examples of cellulose ethers include a methyl cellulose, an ethyl cellulose, and a hydroxypropyl methyl cellulose. When a complementary polymer forms a portion of a treatment composition of layer of a grease-resistant material, the complementary polymer can be less than about 50% by weight of the total polymer present in the material, and/or can have a T_{g} below about 100° C. Examples of complementary polymers that can be incorporated with a cellulose-based polymer include polyvinyl acetates, polyvinyl ethers, polyethyloxazolines, polyamide-epichlorhydrin polymers, polyesters, polyacrylics, polyisocyanates, urea-based polymers, phenolic-based polymers and/or epoxy-based polymers. Any combination of types of cellulose-based polymers and complementary polymers can be mixed together in a composition/layer that meets the functionality desired, though some preferred combinations include wherein the cellulose-based polymer is a cellulose ester and the complementary polymer is a polyvinyl acetate, or wherein the cellulose-based polymer is a cellulose ether and the complementary polymer is a polyvinyl alcohol. These compositions/layers can also include any number of other components such as a dye, an antioxidant, an inorganic filler, and a small-molecule plasticizer.

### DETAILED DESCRIPTION OF EMBODIMENTS

Some embodiments of the present invention are directed to methods and compositions for formulating grease-resistant compositions. Such compositions, also known as “treatment compositions” are directed to protect a variety of substrates including paper-based materials. Paper-based materials include materials typically comprising an amalgam of cellulose fibers, from natural and/or man-made sources. Other types of fillers and additives can also be inserted, either from natural or man-made sources. In particular embodiments, the grease-resistant composition comprises a cellulose-based polymer and a complementary component such as a polymer and/or small molecule plasticizer to modify the cellulose-based polymer's properties. In some embodiments, the grease-resistant composition is a non-porous material, which, while having cellulose-based polymer components, can be in a form that substantially lacks fibers (e.g., the cellulose fibers typically found in a paper-based material).

As utilized within the present application, the term “polymer” refers to a molecule comprising repeat units, wherein the number of repeat units in the molecule is greater than about 10 or about 20. Repeat units can be adjacently connected, as in a homopolymer. The units, however, can be assembled in other manners as well. For example, a plurality of different repeat units can be assembled as a copolymer. If A represents one repeat unit and B represents another repeat unit, copolymers can be represented as blocks of joined units (e.g., A-A-A-A-A-A . . . B-B-B-B-B-B . . . ) or interstitially spaced units (e.g., A-B-A-B-A-B . . . or A-A-B-A-A-B-A-A-B . . . ), or randomly arranged units. In general, polymers include homopolymers, copolymers (e.g., block, inter-repeating, or random), cross-linked polymers, linear, branched, and/or gel networks, as well as polymer solutions and melts. Polymers can also be characterized as having a range of molecular weights from monodisperse to highly polydisperse. In some embodiments of the invention, a grease-resistant composition can comprise at least a portion of a polymer having cellulose-based units.

Some cellulose-based polymers, such as cellulose esters and cellulose ethers, have grease and/or oil resistant properties. However, films and coatings cast from these polymers can be extremely brittle. Accordingly, grease and/or oil can easily leak through small fissures or cracks in such films after the film ruptures. The use of a grease-resistant composition that includes a cellulose-based polymer with a complementary polymer can potentially avoid the creation of such ruptures.

Cellulose-based polymeric materials, as described herein, can be used in a variety of applications, including food packaging applications such as bags for microwavable popcorn, cartons for greasy foods (such as pet foods), or bags for holding frozen fried foods. They can be used over a wide range of temperatures including conditions found in a microwave, and withstand creasing, bending, or folding. Such materials can contain a cellulose-based polymer (e.g., cellulose ester or cellulose ether) and at least one more complementary component. Such a component can act to soften a typically brittle cellulose-based polymer, which can act to provide a composition that can better withstand deformation as could occur in processing or handling. Given the high temperatures (e.g., above about 80° C., 90° C., or 100° C.) to which some of these products are exposed, some embodiments of the present invention utilize grease-resistant compositions that maintain their properties (e.g., grease resistance and/or fatigue resistance and/or tendency to resist leaching) at high temperatures.

### Methods and Compositions for Treating Substrates

Some methods in accord with embodiments of the invention relate to producing grease-resistant products, such as paper products, by coating a substrate surface with a treatment composition. Such treatment compositions can include a cellulose-based polymer and a complementary material such as a complementary polymer and/or a small molecule plasticizer. Beyond providing a grease-resistant coating for the substrate, the treatment composition can form a layer that is less brittle than other grease-resistant barriers such as those made from cellulose-based polymers alone. For instance, when such a grease-resistant barrier is applied to a piece of paper, the paper can be creased without losing its grease/oil resistant properties in a substantial manner.

Films and/or coatings containing a cellulose-based polymer (e.g., a cellulose ester and/or a cellulose ether) described and/or prepared according to embodiments described herein can be used as barriers to prevent the transmission of oil or grease through the film. When the grease-resistant composition is used to treat a substrate (e.g., a paper product) in many embodiments, it can also be referred to as a “treatment composition.” These films or coatings can include free-standing films (i.e., layers which do not require a support substrate upon formation to maintain the layer's structural integrity upon film formation) but are advantageously used as coatings on a substrate such as paper or paper board, or other paper-based material. Free-standing films can be cast on support substrate bodies or molds or in other manners. The free-standing film can also be applied to a substrate through various techniques such as lamination and others known to one skilled in the art. Typical thicknesses of such layers are in a range of about 10 nanometers to about 300 micrometers.

Films and coatings can also be directly coated onto the substrate using such techniques as solvent-casting, spray or dip coating, or extrusion. The films and/or coatings also may provide resistance to other liquids and vapors such as water. Accordingly, a “treatment formulation” can be used to refer to material that is actually coated onto the substrate. The treatment formulation can be the treatment composition or a precursor form of the treatment composition such as the grease-resistant composition diluted in a solvent and/or other components that are eliminated from the final coating upon product formation completion.

In other embodiments, treatment formulations can be utilized simultaneous with the manufacturing of the substrate. In such instances, grease-resistant properties can be embedded with the substrate directly. For example, during the various phases of a paper-making process, a treatment formulation consistent with various embodiments disclosed herein, can be added with the actual components that are used to form a sheet or paperboard.

Treatment formulations can be dissolved or suspended in a solvent, or can be melted and applied without a solvent (e.g., a polymer melt that optionally includes one or more other components). The solvent can be any solvent or solvent combination that dissolves or disperses the polymers and/or other components of the treatment formulation. In some cases, water systems may be preferred but in others, it may be desirable to add quicker drying solvents such as alcohols. Accordingly, some treatment formulations can be formulated as a single phase system (e.g., aqueous phase system) or a meta-stable system, i.e., a system that does not undergo substantial phase separation on the time-scale of formulation preparation and/or coating on the substrate. In such instances, embodiments that utilize a cellulose-based polymer and a complementary polymer can involve a degree of compatibility between the different types of polymers consistent with a single phase system or a meta stable system.

The treatment formulation can also be applied as an emulsion. In an emulsion, the a cellulose-based polymer (e.g., cellulose ester and/or cellulose ether) can be emulsified with a secondary polymer. An example of this would be a cellulose ester emulsified with polyvinyl acetate in water. An emulsifying aid such as a surfactant can be added as well to help stabilize the emulsion. Another emulsion, consistent with embodiments herein, can be formed from water-insoluble cellulose ether, e.g., ethyl cellulose, emulsified with a polyvinyl alcohol, which can be only partially hydrolyzed. Another emulsion can include a solvent with a cellulose-based polymer (e.g., cellulose ester and/or cellulose ether). The solvent can act to soften the cellulose-based polymer, though the polymer is not miscible with water. Emulsions, or particular portions of a emulsion (e.g., an aqueous phase), can be applied using any known coating technique as part of the paper making process (such as in a size press) or as a post treatment on a coating machine. It can be sprayed onto the sheet, extruded onto the sheet, or transferred using a roll to name a few coating technique examples. The treatment composition can be applied to any substrate but it is specifically designed for paper or paperboard.

In some embodiments, a grease-resistant formulation includes a cellulose-based polymer (e.g., a cellulose ester or cellulose ether or combination of cellulose esters and ethers), and a small molecule plasticizer or combination of small molecule plasticizers as the complementary material. A small molecule plasticizer is a plasticizer having an upper bound molecular weight of about 1000 Daltons or about 500 Daltons. As an example, a food-grade plasticizer can be used, such as triacetin. In embodiments, cellulose esters or ethers mixed with food-grade plasticizers can produce a coating that, when applied to a paper product, can allow it to withstand creasing and high temperature application while also hindering oil penetration. Desirably, such products may be useful as food wrappers or bags for greasy foods.

Though a variety of small molecules can act to plasticize a cellulose-based polymer containing layer, it may also be also be advantageous to maintain an enhanced degree of both oil resistance and fatigue resistance in a grease-resistant layer and/or composition. Accordingly, other additives can also be considered that can help a cellulose-based polymer maintain oil/grease resistance while also enhancing fatigue resistance to repeated stresses as would be encountered, for example, in folding and creasing.

Some embodiments are directed to grease-resistant compositions, which can comprise a cellulose-based polymer and a complementary material that does not substantially leach out of the composition. For example, in some situations such embodiments can avoid the addition of substantial amounts of particular types of plasticizers, which can leach out of in the treatment composition after a substrate has been treated. These embodiments can be especially preferred in food applications because such components will not leach into the food product, which can require further downstream processing. In some such instances, a grease-resistant composition can include a cellulose-based polymer (e.g., a cellulose ester or cellulose ether or combination of cellulose esters and ethers) with a polymer or polymers that are compatible with the cellulose-based polymer, i.e., a complementary polymer. The complementary polymer or polymers can enhance the overall mechanical performance of the mixture, especially the fatigue resistance. Therefore the resulting grease-resistant composition is resilient and resists cracking or crazing. In some embodiments, the components of the composition are sufficiently compatible so that large heterogeneous phases do not emerge; such highly phase-separated morphology can detrimentally affect the overall mechanical performance of the composition, promoting film cracking and crazing. As well, using complementary materials that do not leach out in substantial amounts is more likely to preserve the fatigue resistance of a coating, because the presence of the complementary materials may enhance fatigue-resistance.

In yet another embodiment, a combination of the two previously described embodiments can be used. This combination would comprise a cellulose-based polymer (e.g., a cellulose ester and/or cellulose ether), and a complementary component comprising a complementary polymer and a small-molecule plasticizer. Combinations of a cellulose-based polymer, a complementary polymer, and a plasticizer can be formed that have the desirable properties of oil resistance, fatigue resistance and high temperature stability.

### Components of Grease-Resistant Compositions

The following paragraphs describe particular attributes of some components of treatment compositions and treatment formulations that can be used with embodiments described herein. It is understood that any of the components and/or attributes described herein can be mixed with any other components and/or attributes in a consistent manner with embodiments of the invention.

Cellulose-based polymers that can be utilized with the embodiments described herein include various polymers having one or more repeat units that can be cellulose repeat units and/or cellulose-derivative repeat units. Cellulose and cellulose-derivative repeat units can be represented by Structural Formula (I):

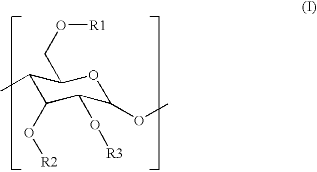

where each of R1, R2, and R3 is independently an organic moiety or a hydrogen atom. For example, when each of R1, R2, and R3 is a hydrogen atom, Structural Formula (I) corresponds with a unit of cellulose.

In some embodiments, the cellulose-based polymer includes a cellulose ester unit, i.e., a cellulose unit in which at least one hydroxyl group is replaced with an ester structure. In terms of Structural Formula (I), at least one of —O—R1, —O—R2, and —O—R3 is an ester unit. Such polymers can be referred to generally as cellulose esters. Cellulose esters can be any specific cellulose ester, cellulose ester derivative, or combination of cellulose ester and ester derivative units. Some non-limiting examples include cellulose acetate, cellulose acetate butyrate, cellulose acetate propionate, and carboxymethyl cellulose acetate butyrate. In some embodiments, the cellulose ester have high hydroxyl content (e.g., a hydroxyl content above about 3% by weight of the polymer).

In another instance, the cellulose-based polymer can include a cellulose ether unit, i.e., a cellulose unit in which at least one hydroxyl group is replaced with an ether structure. In terms of Structural Formula (I), at least one of —O—R1, —O—R2, and —O—R3 is an ether unit. Such polymers can be referred to generally as cellulose ethers. Cellulose ethers can be any cellulose ether, or cellulose ether derivative, which can include but are not limited to cellulose ethers derived from methyl cellulose, ethyl cellulose, and hydroxypropyl methyl cellulose. Cellulose ethers with crystalline domains are preferred such as methyl cellulose in some embodiments. Some embodiments also utilize cellulose ethers having a substantial hydroxyl content. For instance, conversion of less than about 90%, or less than about 60%, of the hydroxyl groups of a cellulose polymer occurs in the cellulose ether. In another instance, about 20% to about 30% of the hydroxyl groups are converted.

Other instances of cellulose-based polymers include copolymers that have any combination of cellulose-based polymer units (e.g., having at least one cellulose ether unit and at least one cellulose ester unit). Some embodiments can utilize a plurality of different types of cellulose-based polymers such as a combination of cellulose ester homopolymers, cellulose ether homopolymers, and/or a mixture of cellulose ester and cellulose ether homopolymers. Various types of homopolymers and copolymers mixtures can also be employed as cellulose-based polymers. Such polymer mixtures can be monodisperse or polydisperse. For example, in some embodiments the cellulose-based polymer can be highly polydispersed. In further instances, the cellulose-based polymers (e.g., cellulose ethers and/or cellulose esters) can be modified to make them more hydrophobic (for example by attaching alkyl groups to substitute for one or more hydroxyl groups) or hydrophilic (e.g., leaving more hydroxyl groups present in the polymer).

The cellulose-based polymers (e.g., cellulose esters and/or ethers) can have an average molecular weight can range from 1,000 up to 10,000,000 Daltons but it is preferable to be between 10,000 to 500,000 Daltons. In some embodiments, cellulose-based polymers (e.g., cellulose esters and/or cellulose ethers) are characterized by viscosity rather than molecular weight. For example, the viscosity of the cellulose-based polymer can be greater than about 2 centipoise, or greater than about 10 centipoise. As an upper limit, an exemplary embodiment can utilize a cellulose-based polymer with a viscosity lower than about 30,000 centipoise. These viscosities can be relative to some type of measurement standard, such as those recognized by one skilled in the art (e.g., ASTM D817 or D1343).

In embodiments in which a small molecule plasticizer is present, a variety of agents can be utilized so long as the agent is compatible with the cellulose-based polymer (e.g., cellulose ester and/or cellulose ether) and other components in the treatment composition. Non-limiting examples of small molecule plasticizers include triacetin, glycol phthalate, diethyl phthalate, tributyl phosphate or dibutyl phthalate. The plasticizer content can be high enough to soften a cellulose-based polymer material, or the remaining combination of the treatment composition, but low enough to retain the oil resistance property. For example, the plasticizer can be in the range of 5-40%. The amount of plasticizer that is suitable depends also on the temperature of the application. For example, high temperature applications use less plasticizer (e.g., a range of about 5-20%). Other combinations of plasticizer and cellulose-based polymers may also be suitable as long as the plasticizer softens the cellulose ester without impairing the oil resistance property of the film.

In some embodiments that utilize a complementary polymer, the polymer can act to soften the resulting film making it less likely to crack or fail upon creasing, folding, or otherwise deforming the coating. In particular, such complementary polymers can provide improved fatigue characteristics for a treatment composition relative to the use of particular small molecule plasticizers. Any polymer that is compatible with a cellulose-based polymer can be utilized, though it is preferred that the complementary polymer act to soften the resulting treatment composition. It is preferable that the complementary polymer have a low T_{g} (e.g., less than 100° C.). The complementary polymer molecular weight can range from 1,000 up to 10,000,000 but it is preferable to be between 10,000 to 500,000 Daltons. In other embodiments, a complementary polymer excludes the use of surfactant-like polymers and oligomers such as alkylpolyglycocides, which can have a tendency to segregate in a treatment formulation, leading to a non-desirable heterogeneous grease-resistant layer.

In some embodiments, a polyvinyl acetate can be used as the complementary polymer. These types of complementary polymers are utilized in some embodiments with a cellulose ester or cellulose ether, and in particular embodiments with celluose esters. The amount of the complementary polymer in the treatment composition should be less than 50% by weight of the total amount of cellulose-based polymer and complementary polymer for high temperature applications (e.g., applications in which the grease-resistant composition is subjected to a temperature above about 100° C.). In one embodiment, a treatment composition with 10% polyvinyl acetate was found to have appropriate properties for high temperature applications. In lower temperature applications, a smaller relative amount of complementary polymer can be utilized. Such temperatures can range from the lower limit of the high temperature range (e.g., less than about 100° C., 90° C., or 80° C.) down to a typical freezer operating temperatures (e.g., higher than about −40° C., −30° C., −20° C., or −10° C.). On paperboard, where more coating flexibility is desired, higher amounts of the complementary polymer can be suitable.

In another embodiment, polyvinyl alcohol can be used as a complementary polymer. Some particular embodiments use polyvinyl alcohol with a cellulose ester or cellulose ether, and in some preferred instances with a cellulose ether. For high temperature applications, a blend with 10% polyvinyl alcohol (e.g., 87%-89% hydrolyzed) was found to have appropriate properties. For paperboard applications, a blend with 40% polyvinyl alcohol was found to have appropriate properties. Other blend proportions will be apparent to those of ordinary skill using no more than routine experimentation in accordance with the methods disclosed herein.

Other types of complementary polymers include those appropriate for combining with a cellulose-based polymer in solution or melt form. Examples include a polyethyloxazoline, a polyamide-epichlorhydrin polymer, polyesters, polyacrylics, polyisocyanates, urea-based polymers, phenolic-based polymers and/or epoxy-based polymers.

Other additives can be added to the treatment compositions consistent with embodiments herein. Preferably, such additives do not overly adversely affect the properties of the treatment composition. For example, inorganic fillers, antioxidants, food dyes and the like may be added. Inorganic fillers can act to lower the cost of the treatment composition. Other examples may be readily apparent to those of ordinary skill in the art.

In some embodiments, the polymers in the treatment composition can be crosslinked. This crosslinking can be performed by including molecules, i.e., crosslinkers, that crosslink the cellulose-based polymers together. Crosslinkers can also crosslink a complementary polymer, if used in the formulation, or the complementary polymer to a cellulose-based polymer. Examples of crosslinking agents include melamine-formaldehyde resins, urea-formaldehyde resins, and epoxidized polyamine-polyamide resins. The crosslinker can be either added into the treatment composition, or applied in a second coating step. Crosslinking may be advantageous so that the treatment formulation can be delivered in a solvent such as water but then not be dissolvable in the solvent after crosslinking.

### EXAMPLES

The following examples are provided to illustrate some aspects of the present application. The examples, however, are not meant to limit the practice of any embodiment of the invention.

In the examples below, the following materials were used:
Cellulose acetate—Eastman Chemical (Kingsport, Tenn.) CA 398-30
Cellulose acetate butyrate—Eastman Chemical (Kingsport, Tenn.) CAB 553-0.4
Carboxymethyl cellulose acetate butyrate—Eastman Chemical (Kingsport, Tenn.) CMCAB 641-0.2
Triacetin—Sigma Aldrich (St. Louis, Mo.) W200700
Polyvinyl acetate—Sigma Aldrich (St. Louis, Mo.) 387924
Castor Oil—Mallinckrodt Baker, Inc. (Phillipsburg, Pa.) 1518-01
Heptane—VWR (West Chester, Pa.) 142-82-5
Toluene—Aldrich (St. Louis, Mo.) 179418
Palm Oil (no specific source)
Methyl Cellulose (15 cps)—Aldrich (St. Louis, Mo.) M7140
Methyl Cellulose (4000 cps)—Aldrich (St. Louis, Mo.) M0512
Poly(vinyl alcohol), 87-89% hydrolyzed—Aldrich (Milwaukee, Wis.) 363103
HT Pigment (Kaolin)—Engelhard Corporation, Iselin, N.J.
Poly(2-ethyl-2-oxazoline)—Aldrich (St. Louis, Mo.) 373974
Precipitated calcium carbonate—Specialty Minerals (New York, N.Y.) Vicality Albaglos 100-0540-3

In the examples below, the coating was prepared as follows: a draw down was performed with the test solution using a 6″ bar with a 5 mil gap. A single coat of the test solution was applied (unless otherwise specified) on a basis sheet and left to air dry.

In the examples below, the following test procedures were used:

The ANSI test, TAPPI test method T 559, which expands upon TAPPI UM 557 “Repellency of Paper and Board to Grease, Oil, and Waxes (Kit Test),” was employed in certain examples. The test involved releasing a drop of a mixture of castor oil, heptane, and toluene (twelve different mixtures are made and numbered 1-12 based on the aggressiveness of the mixture, with 12 being the most aggressive solvent mixture) onto the coating for 15 seconds and determining if the sheet darkened in color. The score was ranked from 1-12 and the coating was given the highest number it passes.

The boat test described below was performed by creating a boat-shaped construct with the coated sheet so that it can hold oil. Briefly, a 5″ by 6″ piece of coated paper was creased in the middle by applying 20 psi of pressure, and then the edges were folded up to create a boat-like structure. Palm oil was placed in the boat and the boat was place in an oven on a piece of paper for 24 hrs at 37° C. The paper underneath the boat was observed for grease spots after the given time and the number and diameter of the spots were recorded.

### Example 1

### 90% Methyl Cellulose

### 4,000 cps in 2% Water Solution

A 3% solids solution was prepared by dissolving 1.62 g methyl cellulose (4,000 cps in 2% water solution) in 60 mL of water. Mix in 0.18 g of polyvinyl alcohol (Mw=124,000-186,000). The basis sheet was coated twice for testing. The coating scored a 12 on the ANSI test and did not leave any grease spots from the boat test. The coat weight was 6.4 g/m².

### Example 2

### 90% Methyl Cellulose

### 15 cps in 2% Water Solution

A 10% solids solution was prepared by dissolving 5.4 g methyl cellulose (15 cps in 2% water solution) in 60 mL of water. Mix in 0.6 g of polyvinyl alcohol (Mw=124,000-186,000). The basis sheet was coated twice for testing. The coating scored a 12 on the ANSI test and did not leave any grease spots from the boat test. The coat weight was 6.4 g/m².

### Example 3

### Increased Solids without Increased Viscosity

A 10% solids solution was prepared by dissolving 5.4 g methyl cellulose (15 cps in 2% water solution) in 60 mL of water then mixing in 0.6 g of polyvinyl alcohol (Mw=124,000-186,000). A final solids concentration of 14.28% was achieved by mixing in 2.571 g Kaolin. This test solution was applied to the basis sheet as a single coat. The coating scored a 12 on the ANSI test and did not leave any grease spots from the boat test. The coat weight was 6.5 g/m².

### Example 4

### 60% Methyl Cellulose

A 10% solids solution was prepared by dissolving 3.6 g methyl cellulose (15 cps in 2% water solution) in 60 mL of water then mixing 2.4 g of polyvinyl alcohol (Mw=124,000-186,000). This test solution was applied to the basis sheet as a single coat. The coating scored a 12 on the ANSI test and did not leave any grease spots on the boat. When two coats are applied to paper board and creased the coat passes 12 on the ANSI test. The coat weight for the paper board was 13.4 g/m².

### Example 5

### 10% Polyethyloxazoline

An 8% solids solution was prepared by dissolving 5.4 g methyl cellulose (15 cps in 2% water solution) in 60 mL of water then mixing in 0.6 g of poly(2-ethyl-2-oxazoline) (Mw=500,000). This test solution was applied to the basis sheet as a single coat. The coating scored a 6 on the ANSI test and left 3 grease spots ranging in diameter between 0.2-0.5 cm. The coat weight was 6.4 g/m².

### Example 6

### Cellulose Acetate with Polyvinyl Acetate

A 16.5% solids solution was prepared by dissolving 30 g of cellulose acetate in 200 mL of 80%/20% acetone/methanol then mixing in 3 g of polyvinyl acetate. This test solution was applied to the basis sheet as a single coat. The coating scored a 12 on the ANSI test and did not leave any grease spots on the boat.

### Example 7

### Cellulose Acetate Butyrate with Polyvinyl Acetate

A 16.5% solids solution was prepared by dissolving 30 g of cellulose acetate butyrate in 200 mL of 95%/5% ethanol/water then mixing in 3 g of polyvinyl acetate. This test solution was applied to the basis sheet as a single coat. The coating scored a 12 on the ANSI test and did not leave any grease spots on the boat.

### Example 8

### Precipitated Calcium Carbonate

A 10% solids solution was prepared by dissolving 5.4 g methyl cellulose (15 cps in 2% water solution) in 60 mL of water then mixing in 0.6 g of polyvinyl alcohol (Mw=124,000-186,000). A final solids concentration of 14.28% was achieved by mixing in 2.571 g precipitated calcium carbonate. This test solution was applied to the basis sheet as a single coat. The coating scored a 12 on the ANSI test and did not leave any grease spots from the boat test. The coat weight was 6.5 g/m².

### Example 9

### Carboxymethyl Cellulose Acetate Butyrate with Polyvinyl Acetate

A 16.5% solids solution was prepared by dissolving 30 g of Carboxymethyl cellulose acetate butyrate and 3 g of polyvinyl acetate in 200 mL of isopropanol. This test solution was applied to the basis sheet as a single coat. The coating scored a 12 on the ANSI test and did not leave any grease spots on the boat.

### Example 10

### Cellulose Acetate with Triacetin

A 16.5% solids solution was prepared by dissolving 31.5 g of cellulose acetate and 1.5 g of triacetin in 200 mL of 80%/20% acetone/methanol. This test solution was applied to the basis sheet as a single coat. The coating did not leave any grease spots on the boat. The ANSI test was not performed.

### Example 11

### Cellulose Acetate Unplasticized

A 16.5% solids solution was prepared by dissolving 33 g of cellulose acetate in 200 mL of 80%/20% acetone/methanol. This test solution was applied to the basis sheet as a single coat. There were 16 grease spots from the boat test with an average diameter of 1.3 cm. The ANSI test was not performed.

### Example 12

### 60% Cellulose Acetate Butyrate

A 25% solids solution was prepared by dissolving 6 g cellulose acetate butyrate in 40 mL of 95%/5% ethanol/water and then mixing in 4 g of polyvinyl acetate. This test solution was applied to the basis sheet as a single coat. The coating scored a 12 on the ANSI test and did not leave any grease spots on the boat. When two coats are applied to paper board and creased the coat passes 12 on the ANSI test. The coat weight for the paper board was 13.4 g/m².

### Example 13

### 10% Kymene

A 7% solids solution was prepared by dissolving 2.1 g methyl cellulose (15 cps in 2% water solution) in 31.466 mL of water. Mix in 1.867 mL of a 12% Kymene solution. This test solution was applied to the basis sheet as a single coat. The coating scored a 12 on the ANSI test with and without a crease.

### Example 14

### 90% Ethyl Cellulose

An 11% solids solution was prepared by dissolving 10 g of ethyl cellulose in 30 mL of water then mixing in 0.333 g of polyvinyl acetate. This test solution was applied to the basis sheet as a single coat. The coating scored a 12 on the ANSI test with and without a crease.

### Example 15

### Cellulose Ester, Polyvinyl Acetate Emulsion

A 5% solids solution was prepared by dissolving 0.1 g cellulose acetate butyrate and 0.4 g polyvinyl acetate in 5 mL of ethyl acetate and 0.25 mL of water. Once dissolved, the solution was homogenized in an ice bath while 10 mL of water was added. The homogenized solution was cooled in the ice bath for 10 minutes to let the ethyl acetate and water phases separate. The aqueous layer was removed and used to coat the basis sheet and left to dry. The coat was heated to 150° C. for 5 minutes. The coat scored a 12 on the ANSI test.

### EQUIVALENTS

While specific embodiments of the subject invention have been discussed, the above specification is illustrative and not restrictive. Many variations of the invention will become apparent to those skilled in the art upon review of this specification. The features illustrated or described in connection with one embodiment may be combined with features of other embodiments. For example, aspects of the use of one complementary polymer in one embodiment can be substituted in other embodiments of grease-resistant compositions. Such modifications and variations are intended to be included within the scope of the present invention. The full scope of the invention should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention. The words “a” and “an” are equivalent to the phrase “one or more.”

1-10. (canceled)

11. A grease-resistant paper product comprising:
a treated surface of a paper-based material, the treated surface including a layer of a treatment composition comprising a cellulose-based polymer and a complementary polymer, the treatment composition layer being less brittle than an equally thick layer of the cellulose-based polymer, the treated surface of the paper-based material being more grease-resistant than an untreated surface of the paper-based material.

12. The grease-resistant paper product of claim 11, wherein the layer of the treatment composition is substantially free of cellulose fibers.

13. The grease-resistant paper product of claim 11, wherein the layer of the treatment composition exhibits limited phase-separation morphology.

14. The grease-resistant paper product of claim 11, wherein the treatment composition is substantially free of a small molecule plasticizer.

15. The grease-resistant paper product of claim 14, wherein the cellulose-based polymer is a cellulose ester and the complementary polymer is a polyvinyl acetate.

16. The grease-resistant paper product of claim 14, wherein the cellulose-based polymer is a cellulose ether and the complementary polymer is a polyvinyl alcohol.

17. The grease-resistant paper product of claim 11, wherein the cellulose-based polymer comprises at least one of a cellulose ether and a cellulose ester.

18. The grease-resistant paper product of claim 11, wherein the cellulose-based polymer comprises a high hydroxyl content.

19. The grease-resistant paper product of claim 11, wherein the cellulose-based polymer comprises a cellulose ester, the cellulose ester including at least one of a cellulose acetate, a cellulose butyrate, a cellulose propionate, and a carboxymethyl cellulose.

20. The grease-resistant paper product of claim 11, wherein the cellulose-based polymer comprises a cellulose ether, the cellulose ether including at least one of a methyl cellulose, an ethyl cellulose, and a hydroxypropyl methyl cellulose.

21. The grease-resistant paper product of claim 11, wherein the cellulose-based polymer comprises a cellulose ether with crystalline domains.

22. The grease-resistant paper product of claim 11, wherein the complementary polymer comprises at least one of a polyvinyl acetate, a polyvinyl ether, a polyethyloxazoline, a polyamide-epichlorhydrin polymer, polyesters, polyacrylics, polyisocyanates, urea-baed polymers, phenolic-based polymers and/or epoxy-based polymers.

23. The grease-resistant paper product of claim 11, wherein the complementary polymer has a T_{g} below about 100° C.

24. The grease-resistant paper product of claim 11, wherein the complementary polymer is less than about 50% by weight of a total polymer weight in the treatment composition.

25. The grease-resistant paper product of claim 11, wherein the treatment composition further comprises at least one of a dye, an antioxidant, and a small-molecule plasticizer.

26. The grease-resistant paper product of claim 11, wherein the treatment composition further comprises an inorganic filler.

27. The grease-resistant paper product of claim 11, wherein the treatment composition is crosslinked with a crosslinking agent.

28. The grease-resistant paper product of claim 11, wherein the grease-resistant paper product is configured as a food packaging material.

29. The grease-resistant paper product of claim 11, wherein the treatment composition maintains grease-resistant properties above about 80° C.

30-33. (canceled)

34. A grease-resistant composition for laminating upon a substrate, comprising:
a free standing grease-resistant layer comprising a cellulose-based polymer and a complementary polymer, the layer being less brittle than an equally thick layer of the cellulose-based polymer, the layer capable of repelling a grease-based fluid and adapted to be attached to the substrate.

35. The grease-resistant composition of claim 34, wherein the layer exhibits limited phase-separation morphology.

36. The grease-resistant composition of claim 34, wherein the layer is substantially free of a small molecule plasticizer.

37. The grease-resistant composition of claim 34, wherein the cellulose-based polymer comprises at least one of a cellulose ether and a cellulose ester.

38. The grease-resistant composition of claim 37, wherein the cellulose-based polymer is a cellulose ester and the complementary polymer is a polyvinyl acetate.

39. The grease-resistant composition of claim 37, wherein the cellulose-based polymer is a cellulose ether and the complementary polymer is a polyvinyl alcohol.

40. A grease-resistant layer comprising:
a layer of a treatment composition comprising a cellulose-based polymer and a complementary polymer, the layer being less brittle than an equally thick layer of the cellulose-based polymer, the layer capable of repelling a grease-based fluid.

41. The grease-resistant layer of claim 40, wherein the layer is substantially free of cellulose fibers.

42. The grease-resistant layer of claim 40, wherein the layer exhibits limited phase-separation morphology.

43. The grease-resistant layer of claim 40, wherein the layer is substantially free of a small molecule plasticizer.

44. The grease-resistant layer of claim 40, wherein the cellulose-based polymer comprises at least one of a cellulose ether and a cellulose ester.

45. The grease-resistant layer of claim 44, wherein the cellulose-based polymer is a cellulose ester and the complementary polymer is a polyvinyl acetate.

46. The grease-resistant layer of claim 44, wherein the cellulose-based polymer is a cellulose ether and the complementary polymer is a polyvinyl alcohol.

47-49. (canceled)

50. The grease-resistant paper product of claim 11, wherein the complementary material is incapable of substantial leakage out of the layer.
